(19) United States
(12) Patent Application Publication
(10) Pub. No.: US 2026/0324898 A1
(43) Pub. Date: Oct. 22, 2026

(54) Lever Espresso Maker

(71) Applicant: WISys Technology Foundation, Inc., Madison, WI (US)

(72) Inventor: Aliosha Alexandrov, Appleton, WI (US)

(21) Appl. No.: 19/648,479

(22) Filed: Apr. 15, 2026

Related U.S. Application Data
(60) Provisional application No. 63/789,553, filed on Apr. 16, 2025.

(51) Int. Cl. A47J 31/06; A47J 31/30; A47J 31/46; A47J 31/52; A47J 31/54

(52) U.S. Cl. CPC A47J 31/0657; A47J 31/30; A47J 31/461; A47J 31/468; A47J 31/52; A47J 31/54; A47J 31/469

(57) ABSTRACT

An espresso machine places the water heater adjacent to the coffee puck to reduce cooling of water from the pump mechanism which is placed upstream from the water heater. Separation of these functions allows a longer lever arm providing improved mechanical advantage. Pumping of lower temperature water simplifies pump design and improves operation.

### CROSS REFERENCE TO RELATED APPLICATION

The present application claims the benefit of U.S. provisional application 63/789,553 filed Apr. 16, 2025, and hereby incorporated by reference.

### BACKGROUND OF THE INVENTION

The present invention relates generally to espresso machines and in particular a lever-operated espresso machine having improved control and thermal response.

Espresso is a concentrated coffee drink made by forcing hot water through a “puck” of packed, finely ground coffee beans. Automatic espresso machines pump water using an electrical pump in contrast to lever operated espresso machines that, as the name suggests, employ a manually operated lever and piston pump.

Lever-operated machines may be preferred for a number of reasons including: durability, silent operation, the satisfaction of manual operation, and better control that can lead to better tasting espresso. Lever operated machines, however, place a substantial thermal mass of the lever-operated piston immediately before the coffee grounds making it difficult to attain and maintain temperature of the water forced through the coffee grounds. Lever operated machines often continue to drip water and coffee after the lever is released.

### SUMMARY OF THE INVENTION

The present invention moves the lever pump to a position upstream from the boiler allowing the pump structure to be maintained at a low temperature without preheating or affecting temperature stability of the water received by the coffee grounds which now comes directly from the boiler. Displacement of this pump also allows for a longer lever arm reducing the amount of force required on the lever arm while still allowing precise control. Moving the volume of the pump away from the coffee simplifies the incorporation of a relief solenoid, for example, in the boiler, that can remove pressure that causes after-shot dripping.

These particular objects and advantages may apply to only some embodiments falling within the claims and thus do not define the scope of the invention.

### BRIEF DESCRIPTION OF THE DRAWINGS

FIG. 1 is a perspective view of an espresso machine constructed according to the present invention showing a rear mounted water pump with a lever extending forwardly to a handle in front of the group head and portafilter;

FIG. 2 is a side elevational fragmentary detail of the water pump; and

FIG. 3 is a block diagram of the relationship between the water pump and the other components of the espresso machine including a dual boiler, group head, and portafilter.

### DETAILED DESCRIPTION OF THE PREFERRED EMBODIMENT

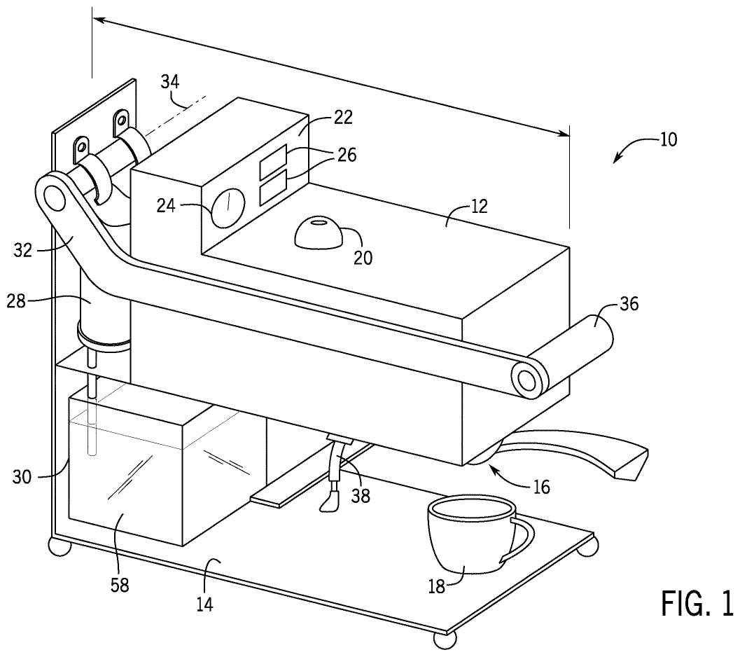

Referring now to FIG. 1, an espresso machine 10 constructed according to the present invention may provide a main housing 12 positioned over and spaced above a support platform 14, the latter of which may rest on a table or other horizontal surface. A front lower edge of the housing 12 supports a portafilter 16 positioned over a portion of the support platform 14 where a cup 18 may be placed to receive espresso shots.

An upper surface of the housing 12 may expose the operator of a steam control valve 20 controlling steam to the steam wand 38 as will be discussed below. A rear edge of the housing 12 provides an upwardly extending console face 22 providing a pressure gauge 24 and temperature gauges 26 for a pair of PID temperature controllers for the espresso steam boiler and water boiler as will be discussed below.

Positioned rearward from the housing 12 is a piston water pump 28 that may receive water from a water reservoir 30 supported on the upper rear surface of the platform 14 below the piston water pump 28. The piston water pump 28 may be operated by a lever 32 pivoting about a horizontal axis 34 and extending along a side of the housing 12 to a handle 36 that may be grasped by the operator during operation of the machine 10.

A steam wand 38 may extend beneath and to the side of the housing 12 for the provision of steam for making a frothy foam for cappuccinos and lattes.

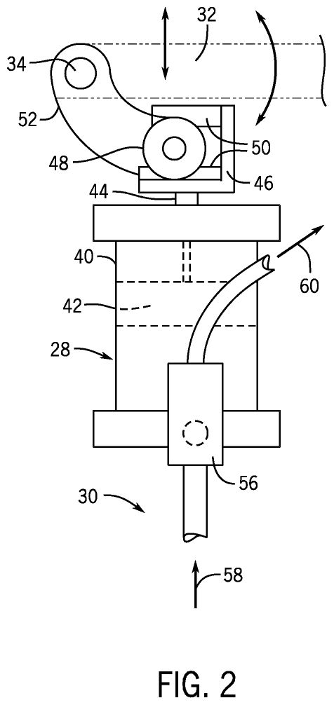

Referring now to FIG. 2, the piston water pump 28 may provide a vertically oriented and generally cylindrical piston chamber 40 holding an internal piston 42 that may slide vertically within the piston chamber to change a constrained volume beneath the piston 42. The piston 42 may communicate upwardly by means of a shaft 44 through an upper end of the piston chamber 40 to a roller track 46 capturing a grooved roller 48 held by inwardly curved track elements 50 to roll smoothly within the track 46 constrained vertically but not horizontally.

The roller 48 attaches to a first short lever arm 52 to pivot about the axis 34 rotationally connected to the lever 32 so that motion of the lever 32 moves the piston 42 upwardly and downwardly in the piston chamber 40. A difference between the length of the short lever arm 52 and the lever 32 will provide substantial mechanical advantage, for example, in excess of 10 to 1.

A pair of unidirectional check valves 56 provide that, with upward motion of the piston 42 (and lever 32), water 58 is drawn from the reservoir 30 and then expelled as pressurized water 60 during a downward stroke of the piston 42 (and lever 32).

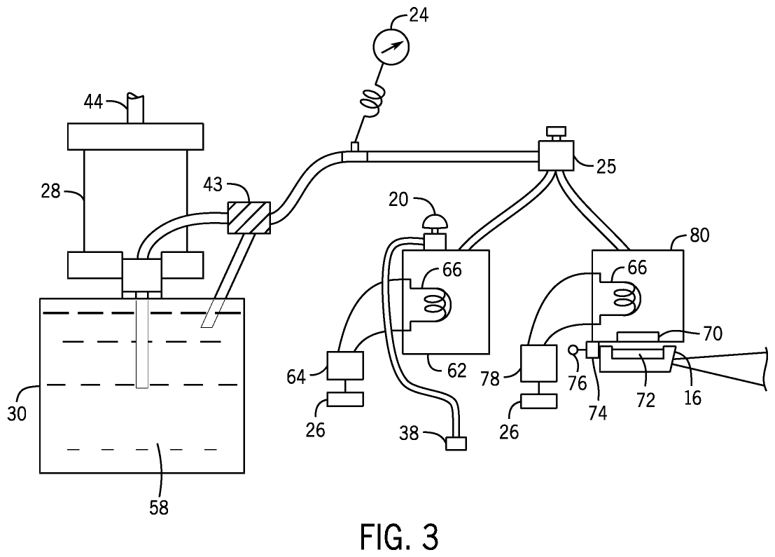

Referring now to FIG. 3, the pressurized water may pass first to a solenoid valve 43 electrically controllable to provide either a path back to the reservoir 30 or a connection to the pressure gauge 24 and a three-way ball valve 25. Water from the three-way ball valve 25 may be received by both the steam boiler 62 to provide pressurized steam and by a water boiler 80 providing espresso water to be heated to temperatures of 90 to 96° C. Each of the steam boiler 62 and water boilers 80 are controlled by PID controllers 64 and 78, respectively, providing electrical power to an internal heating coil 66. The steam from the steam boiler 62 is provided through the steam control valve 20 to the steam line 68. The water from the water boiler 80 is provided to a shower head fitting 70 attached to the removable cup of the portafilter 16 by a gasket, the water then passing forcibly through a puck 72 of coffee per espresso machine design to be discharged into the cup 18.

A pressure relief solenoid valve 74 may be electrically actuated, for example, by a button 76 to block the flow of water and/or relieve pressure from the water boiler 80 immediately after the shot is pulled (occurring with downward motion of the lever 32) to reduce dripping.

It will be appreciated that a variety of different heater designs can be used for the water boiler 80 including a conventional boiler, a heat exchanger design, a thermoblock or thermocoil or the like.

While the inventor does not wish to be bound by a particular theory, is believed that this design presents a number of nonobvious advantages over the prior art:

Because the lever need not be in the front of the machine, it can be made longer to provide more mechanical advantage and require less physical effort. This configuration also allows a piston with a larger stroke volume, which will allow longer espresso shots typically impossible under the traditional design or greater pressure.

Because the pump is removed from the group head, it can operate at lower temperatures (and be manufactured of lower temperature materials) and does not cool the water from the boiler which can adversely affect control of the temperature received by the coffee.

Further, placing the water boiler right on top of the portafilter improves the thermal stability versus the traditional lever machines where the boiler must be separated from the group head because of the piston.

The ability to place a pressure relief valve immediately ahead of the portafilter, possible because of the new positioning of the piston eliminates interference with the valve, reduces the amount of dripping after a shot is taken.

Unlike electrical pump designs, the user has full control over the extraction process. The better espresso taste of lever machines is achieved by removing the pressure fluctuations of the vibratory pump or the rapid pressure increase of rotary pumps.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. An espresso machine comprising:
a portafilter adapted to removably hold a puck of compressed coffee for passage of hot water into a showerhead then through the puck to an outlet for discharge into a cup;
a water heater communicating with the showerhead to provide hot water thereto;
a water pump having a lever operator, the water pump receiving water from a water reservoir to pressurize water within the water heater;
whereby operation of the lever forces water through the water heater into the showerhead for passage through the puck before discharge into the cup.

2. The espresso machine of claim 1 wherein pressurization of water occurs within the water heater independently of instantaneous position of the lever operator.

3. The espresso machine of claim 1 wherein the water pump is configured to be actuated multiple times to introduce additional water into the water heater during an extraction process.

4. The espresso machine of claim 1 wherein the lever operates about a pivot point displaced from a front of the espresso machine.

5. The espresso machine of claim 2 wherein the portafilter is positioned at a front end of the espresso machine and the water pump at a rear end of the espresso machine and the lever extends by a length of the espresso machine from the rear end to the front end.

6. The espresso machine of claim 1 wherein the water heater is adjacent to and above the showerhead.

7. The espresso machine of claim 1 wherein the water pump is a piston pump having a piston sliding within a cylinder as moved by a shaft and wherein the lever provides a handgrip at a front of the espresso machine for movement of a first lever arm of the lever with respect to a pivot by manual manipulation and wherein the lever includes a second lever arm with respect to the pivot communicating with the shaft and the ratio of the first lever arm to the second lever arm is in excess of 10:1.

8. The espresso machine of claim 1 further including a fluid control system having at least one valve configured to selectively control flow or pressure between the reservoir, water pump, water heater, and portafilter.

9. The espresso machine of claim 1 wherein the water in the reservoir and water pump is at substantially room temperature.

10. A method of operating an espresso machine having a pump, a water heater, and a group head, the method comprising:
actuating the pump to deliver water from a reservoir to the water heater;
pressurizing water within the water heater using the pump; and
delivering pressurized water from the water heater to the group head for passage through a puck of coffee.

11. The method of claim 10, further comprising selectively controlling or relieving pressure within the upstream pump and intermediate chamber system, including at least one of the pump, the water heater, or a fluid path between the water heater and the group head during operation of the espresso machine.
